(19) United States
(12) Patent Application Publication
(10) Pub. No.: US 2016/0241848 A1
(43) Pub. Date: Aug. 18, 2016

(54) Method of Testing Graphics Displayed by a Display Device

(71) Applicants: Robert Bosch GmbH, Stuttgart (DE); Robert Bosch Engineering and Business Solutions Limited, Bangalore (IN)

(72) Inventors: Kela Ranjith Ramakrishnan, The Nilgiris (IN); Sandhana Mohan Palanisamy, Coimbatore (IN)

(21) Appl. No.: 15/041,264

(22) Filed: Feb. 11, 2016

(30) Foreign Application Priority Data
Feb. 16, 2015 (IN) 743/CHE/2015

(51) Int. Cl. H04N 17/00; G06T 7/20

(52) U.S. Cl. CPC H04N 17/004; G06T 7/204

(57) ABSTRACT

A method of testing graphics displayed by a display device is disclosed. The method includes receiving contents of at least one image displayed on the display device, retrieving at least one of a reference object and a reference location from a memory, detecting if the reference object is present in said contents of said image at said reference location, and providing graphic test result based on the detection.

The following specification describes and ascertains the nature of this invention and the manner in which it is to be performed:

### FIELD OF THE INVENTION

This invention relates to a method of testing graphics displayed by a display device.

### BACKGROUND OF THE INVENTION

Automatic testing techniques are used for testing graphics displayed on a display device. A testing device embedded with diagnostic software is connected to the display device for testing the display device. Usually, the testing device transmits a test command to the display device. The display device upon receiving the test commands will execute the test command and provide a result in response to the test command. This result is captured by the testing device and further the testing device analyses the result to determine if the display device displays the result as desired.

According to an Indian application document IN201302900 discloses a technique of automatic graphical user interface technique in a non-standard display device. The method includes configuring a display screen of the non standard display device with an interpretation and reconstruction module, executing at least one of a plurality of test cases on the nonstandard display device using the interpretation and reconstruction module, interpreting a display content corresponding to the executed test case using the interpretation and reconstruction module and verifying the reconstructed display content using an automation module.

### BRIEF DESCRIPTION OF THE ACCOMPANYING DRAWINGS

Different embodiments of the invention are disclosed in detail in the description and illustrations in the accompanying drawings:

FIG. 1 is a method of testing graphics displayed by a display device, in accordance with an embodiment of the present disclosure;

FIG. 2 is a block diagram that illustrates an apparatus for testing graphics displayed by a display device in accordance with an embodiment of the present disclosure; and

FIG. 3 is an exemplary illustration of testing graphics displayed by a display device in accordance with an embodiment of the present disclosure.

### DETAILED DESCRIPTION

FIG. 1 is a method of testing graphics displayed by a display device, in accordance with an embodiment of the present disclosure.

The method includes receiving contents of at least one image displayed on the display device, retrieving at least one of a reference object and a reference location from a memory, detecting if the reference object is present in the contents of the image at the reference location and providing graphic test result based on the detection.

At step 105, the contents of the image displayed on the display device are received from a camera or a frame grabber or image transmitting interface. The contents of the image displayed on the display device are a result of a test command executed by the display device. The test command is provided by an apparatus to the display device. The apparatus is used for testing graphics displayed by the display device. The image includes all or part of the contents displayed on the display device. In one example, the contents may include a symbol, an icon, text, number and the like. An image-capturing device such as the camera or the frame grabber or image-transmitting interface captures the contents of the image displayed by the display device and transmits it to the apparatus that performs testing of the graphics displayed by the display device. The camera or the frame grabber or image-transmitting interface may be included as a part of the apparatus that is used for testing the graphics or they can be separate units that transmit the captured contents of the image to the apparatus for testing.

At step 110, a reference object and a reference location is retrieved from a memory. The reference object and the reference location may be retrieved from the memory of the apparatus or the memory of the display device. If the reference object and the reference location are retrieved from the memory of the display device then various communication protocols may be used so that the reference object and the reference location are retrieved by the apparatus that is used for testing the graphics. The reference object is referred to as a particular object that is to be searched for testing correctness of the graphic displayed by the display device. The reference object includes a symbol, an icon, text and a number and the like. The reference location may be a specific location on the display device where the reference objet is displayed. The reference location may also be a sub area of the display device. In one example, the sub area includes quadrants such as upper right quadrant, upper left quadrant, lower right quadrant and lower left quadrant of the display device. Presence of the reference object at the reference location of the display device upon testing the contents of the image displayed on the display device determines the correctness of the graphic testing.

At step 115, it is detected if the reference object is present in the contents of the image based on the reference. Detection is performed using one or more image processing algorithms. Upon retrieving the reference location, the image processing algorithms will search for the reference object in a specific location of the image that corresponds to the retrieved reference location. By searching for the reference object at the reference location, the method for testing graphics is time efficient since the search for the reference object is limited to a specific location on the display device.

In one case, if the contents include text then the character, size and color of the text displayed on the display device can be tested. In such cases, reference object that is stored in the memory is a reference text. The text displayed by the display device is retrieved by the apparatus for testing the graphics. Further, the retrieved text is validated for ASCII and UNICODE. The detected text is compared with the reference text to determine if the retrieved text is equivalent to the reference text that is stored in the memory.

Further, the size and color of the text can also be tested. The reference text is usually associated with a reference size. For determining the size, the size of the retrieved text is determined. The size of the retrieved text is then compared with the reference size to determine if the size of the retrieved text is same as the reference size.

Similarly, color of the text displayed on the display device can also be detected. The text is retrieved and the color of the text is determined using various color detecting algorithms. Also, for determining the color, a reference color code is associated with the reference object and is stored in the memory. Upon determining the color of the retrieved text, the determined color is compared with the reference color code stored in the memory.

At step 120, the graphic test result is provided based on the detection. If the reference object is present at the reference location in the contents of the image displayed on the display device then it is considered that the graphical test result is positive. If the reference object is not present at the reference location in the contents of the image displayed on the display device then the graphical test result is considered negative. The test result that is negative can be further used for analysis by a user, for example, a developer.

In another case, it is detected if the reference object is present in the contents of the image without considering the reference location. In such cases, the reference object is searched to determine if it is present anywhere on the display device. If the reference object is present anywhere in the display device then the graphical test result is considered positive.

In cases where the contents include text, if the character, size and color are equivalent to the reference character, the reference size and the reference color associated with the text then the graphic test result is considered positive.

The method further comprises calculating rate of change of reference object position in a plurality of images to determine smooth movement of the reference object in the contents of the image. In a graphic image, the smooth movement determines if the reference object is moving as desired so that the graphic image is jitter free. Hence, the reference object position is calculated in multiple images to determine the smooth movement of the object.

The rate of change of reference object position is calculated by receiving a plurality of images sequentially that are captured by an image-capturing device such as the camera and the frame grabber or the image-transmitting interface. Further, the distance of the reference object from a reference point in each of the images is calculated. The reference point includes a specific location in first image of the plurality of images.

Further, smooth movement of the reference object in the contents of the image is determined by comparing the calculated distance of the reference object in each image from the reference point with a plurality of pre stored distances or previously calculated distances. The pre stored distances or previously calculated distances correspond to the distance between the reference object positions in each of the images from the reference point. If the calculated distance of the reference object position in each of the images is equal to, with or without pre-defined tolerance, the pre-stored distance or previously calculated distance for corresponding images then the reference object movements on the display device is smooth and jitter free.

In order to understand the calculation of the rate of change of reference object position, an exemplary explanation is provided in this paragraph. Consider that 2 images are captured by the image-capturing device and these 2 images are received sequentially by the apparatus that performs graphic testing. Let the reference object remain at a reference point in the first image at (x1, y1). Now for calculating smoothness, the distance of the reference object in the second image from the reference point (x1, y1) is measured. Further, the distance measured is compared with a stored distance that is stored in the memory. The stored distance indicates the distance between the reference point (x1, y1) in the first image and another point (x2, y2) in the second image. If the distance measured is within an acceptable band compared to the stored distance then the reference object position is as desired and the reference object movement is smooth. Similarly, the distance of the reference object in various images from the reference point can be measured and the measured distance is compared with multiple pre stored distances or previously calculated distance for each of the images. If the measured distance is equal to the pre stored or previously calculated distances for each of the images then the reference object movements is smooth and jitter free.

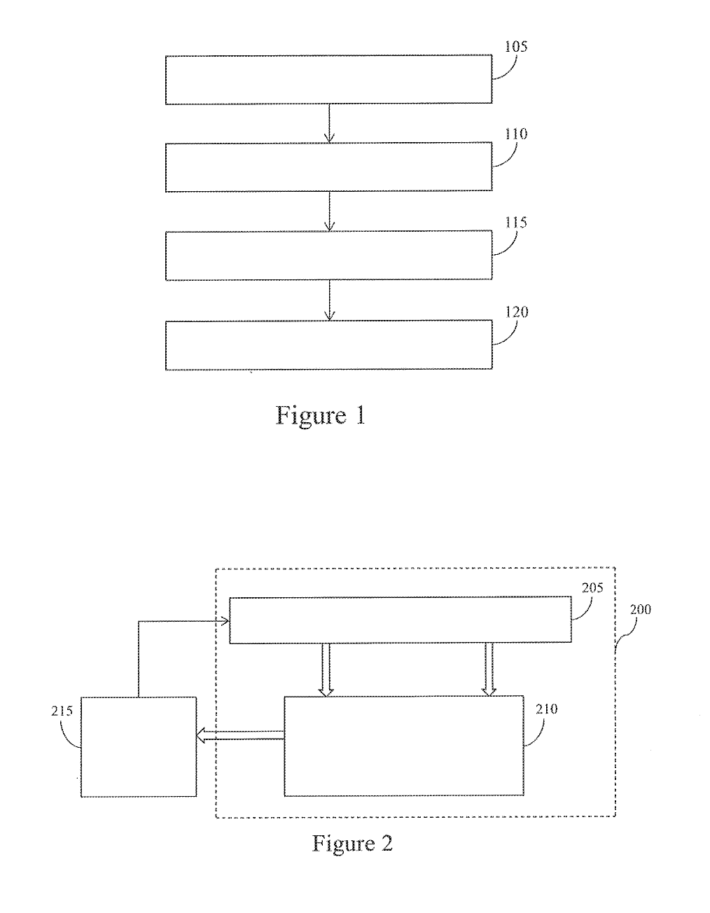

FIG. 2 is a graphic testing system for testing graphics displayed By a display device.

The apparatus 200 transmits a test script to the display device 215. The display device is also referred to as a device under test (DUT). The contents of the images displayed by the display device 215 are tested by the apparatus.

The test script is executed by the DUT 215 and a result of the test script is displayed on the display device 215. The result is the contents of an image displayed on the display device 215. The contents of the image are then captured by an image-capturing device such as a camera, a frame grabber or an image-transmitting interface. The result displayed by the display device 215 that is captured by the image-capturing device is referred to as the image.

The image-capturing device may be included as a part of the apparatus 200 or the display device 215. In some cases, the image-capturing device may be a separate unit that is not a part of the apparatus 200 and the display device 215 that captures the contents of the image displayed by the display device 215 and transmits the captured image to the apparatus 200.

The apparatus 200 comprises an interface 205 for receiving the contents of the images displayed by the display device 215 from the camera or the frame grabber. The interface 205 includes hardware and software components adapted to receive the contents of the image. The contents of the image include, but are not limited to, an icon, a symbol, a text a number and the like.

The apparatus 200 also comprises a processor 210 adapted to retrieve at least one of a reference object and a reference location from a memory. The memory can be included in the apparatus or the memory can be a part of the display device. If the reference object and the reference location is stored in the memory of the display device, then various communication protocols may used so that the apparatus retrieves the reference object and the reference location from the memory of the display device.

Upon retrieving the reference object and the reference location, the processor 210 detects if the reference object is present in the contents of the image at the reference location. The reference object may include, but is not limited to, an icon, a symbol, text, a number and the like. The reference location is a specific location of the display device. One or more image processing algorithms embedded in the apparatus is used for detecting the reference object in the reference location. By searching for the reference object at the reference location, the graphic testing process would be time efficient since the search is limited to a specific location.

In some cases, the processor 210 is adapted to detect if the reference object is present in the contents of the image without considering the reference location. In such cases, it is tested if the reference object is present anywhere on the display device. Detection of the reference object at the reference location or detection of the reference object anywhere on the display device depends on the test script.

Upon detecting the reference object, the processor 210 provides graphic test result based on the detection. If the reference object is present in the contents of the image displayed by the display device at the reference location then the graphic test result is said to be positive. In some cases, if the reference object is present anywhere in the display device 215 then the graphic test result is said to be positive. The graphic test result may be displayed on the display device or on a display of the apparatus. The graphic test results may also be presented in the form of an audio.

The processor 210 is also adapted to calculate rate of change of reference object position in a plurality of images to determine smooth movement of the reference object. For calculating the rate of change of reference object position, the position of the reference object is monitored in multiple images. For determining the position of the reference object, the processor 210 determines distance of the reference object in each of the images from a reference point. The reference point corresponds to a specific location in the first image of the multiple images.

Further, the processor 210 determines smooth movement of the reference object based on calculated rate of change of reference object position. The smooth movement is determined to check if the reference object movement in a graphic image is jitter free when displayed on the display device. The processor 210 compares the distance of the reference object in each of the images from the reference point with pre-stored or previously calculated distances that correspond to each of the images. If the distance of the reference object with respect to the reference point in each image is equal to the pre-stored previously calculated distance that correspond to that particular image then the reference object movement is smooth and jitter free.

By detecting the reference objects in the contents of the image displayed at the reference location, the disclosure enables graphic testing in a time efficient manner. Further by determining rate of change of reference object position, smooth movement of the reference object on the display device can be determined thereby eliminating need for complex software tools for determining smooth movement of the graphic image.

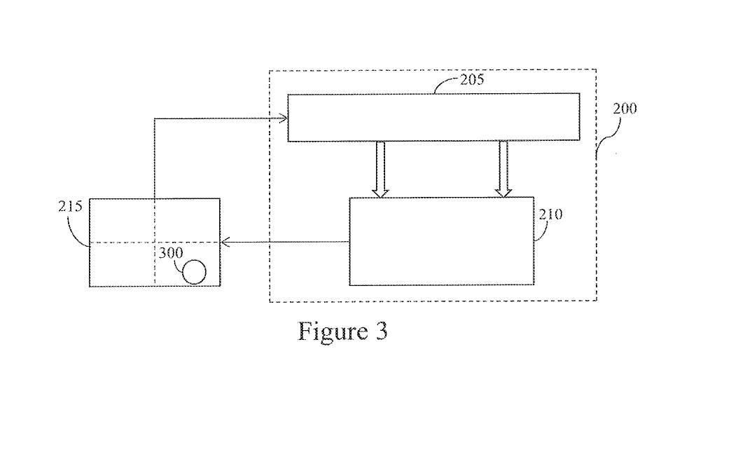

FIG. 3 is an exemplary illustration of testing graphics displayed by a display device in accordance with an embodiment of the present disclosure. The apparatus 200 transmits a test script to the display device 215. In this example, the test script is a command for an incoming call.

The test script is executed by the DUT 215 and the result of the test script is to display a phone icon 300 on the right bottom of the display device 215 upon receiving the test script. The apparatus 200 is adapted to test if the icon 300 is displayed on the right bottom of the display device 215.

The image that includes the entire display device 215 is captured by a camera, a frame grabber or an image-transmitting interface. The contents of the image that includes the phone icon 300 is captured. The captured image is transmitted to the apparatus 200 through the interface 205.

Upon receiving the image that includes the contents displayed by the display device 215, the processor 210 now retrieves a reference object and a reference location from a memory. With respect to this example, the reference object is the phone icon 300 and the reference location includes a sub area of the display device 215. With respect to this example, the sub area is right bottom of the display device 215.

Upon retrieving the reference object and the reference location, the processor 210 searches for the phone icon 300 only in the sub area, right bottom of the display device 215. Upon spotting the phone icon 300, the processor 210 compares the phone icon 300 with the reference object to determine if the phone icon 300 is similar to the reference object retrieved. By limiting the search for the phone icon 300 within the sub area, right bottom of the display device 215, the graphic testing process would be time efficient since the search is limited to a specific location.

Upon detecting the phone icon 300 at the right bottom of the display device 215, the processor 210 provides graphic test result based on the detection. In this example, the graphic test result is positive because the phone icon 300 is similar to the reference object and further, the phone icon 300 is present at a location similar to the reference location. The graphic test result may be displayed on the display device 215 or on a display of the apparatus. The graphic test results may also be presented in the form of an audio.

It must be understood that the embodiments explained in the above detailed description is only illustrative and does not limit the scope of this invention. Many modifications in the embodiments are envisaged and form a part of this invention. The scope of this invention is limited only by the scope of the claims.

1. A method of testing graphics displayed by a display device, the method comprising:
receiving contents of at least one image displayed on the display device;
retrieving of a reference object and a reference location from a memory;
detecting if the reference object is present in the contents of the at least one image at the reference location; and
providing a graphic test result based on the detection.

2. The method as claimed in claim 1, wherein the reference object includes at least one of a symbol, an icon, text and a number.

3. The method as claimed in claim 1, wherein the reference location includes at least one of a specific point on the display device and a sub area of the display device.

4. The method as claimed in claim 1 further comprising:
calculating a rate of change of a position of the reference object in a plurality of images to determine smooth movement of the reference object in contents of the at least one image.

5. The method as claimed in claim 4, wherein the calculation of the rate of change of the position of the reference object comprises:
receiving a plurality of images that are sequentially captured by an image capturing device; and
calculating a distance of the reference object from a reference point in each of the plurality of images, the reference point including a location in a first image of the plurality of images.

6. The method as claimed in claim 4, wherein the determining of smooth movement of the reference object in the contents of the at least one image comprises:
comparing the calculated distance of the reference object from the reference point in each of the plurality of images with a distance value stored in the memory; and
determining a smooth movement of the display device based on the comparison.

7. An apparatus for testing graphics displayed by a display device, the apparatus comprising:
an interface configured to receive contents of at least one image displayed on the display device; and
a processor configured to:
retrieve a reference object and a reference location from a memory;
detect if the reference object is present in the contents of the at least one image at the reference location; and
provide a graphic test result based on the detection.

8. The apparatus as claimed in claim 7, wherein the contents of the at least one image are received from a camera.

9. The apparatus as claimed in claim 7, wherein the contents of the at least one image are received from at least one of a frame grabber and an image transmitting interface.

10. The apparatus as claimed in claim 7, the processor being further configured to:
calculate a rate of change of a position of the reference object in a plurality of images to determine a smooth movement of the reference object in the contents of the at least one image.
